(19) United States
(12) Patent Application Publication
(10) Pub. No.: US 2011/0063649 A1
(43) Pub. Date: Mar. 17, 2011

(54) PRINTER AND TASK CONTROL METHOD

(75) Inventor: Tadahiro Komatsu, Shizuoka (JP)

(73) Assignee: TOSHIBA TEC KABUSHIKI KAISHA, Tokyo (JP)

(21) Appl. No.: 12/868,971

(22) Filed: Aug. 26, 2010

(30) Foreign Application Priority Data
Sep. 16, 2009 (JP) 2009-214648

(51) Int. Cl. G06K 15/00

(52) U.S. Cl. 358/1.14

(57) ABSTRACT

According to one embodiment, a printer includes a direct current power input unit supplied with direct current, a rechargeable battery capable of being charged with the direct current power inputted from the direct current power input unit, and a task priority changing unit capable of determining the operational priority of a charge monitoring task to be higher than the operational priorities of other tasks when the rechargeable battery is being charged with the direct current power inputted from the direct current power input unit, and for determining the operational priority of the charge monitoring task to be lower than the operational priority of at least one of other tasks when the rechargeable battery is not being charged with the direct current power inputted from the direct current power input unit.

### CROSS-REFERENCE TO RELATED APPLICATIONS

This application is based upon and claims the benefit of priority from Japanese Patent Application No. 2009-214648, filed on Sep. 16, 2009, the entire contents of which are incorporated herein by reference.

### FIELD

Embodiments described herein relate to a printer, program and a task control method.

### BACKGROUND

A portable printer is widely used in such applications as door-to-door delivery and inventory management. In one method of using the portable printer, a label with a backing sheet is wound in a roll and loaded into the portable printer. The portable printer pulls the labels through the printer and prints accumulated print data onto the labels which are bonded to the backing sheet. The printed labels are separated from the backing sheet and dispensed from a paper outlet.

In the aforementioned portable printer, after a specified time period has lapsed from a standby mode while being operated with the rechargeable battery, the standby mode is changed over to an energy-saving sleep mode to reduce power consumption.

When in the sleep mode, however, the processing speed of a central processing unit for controlling each of the units is reduced approximately by one half. Since the processing speed of the central processing unit is slowed in the sleep mode, a problem occurs since the processing of a specified task is delayed. For example, when driving the portable printer, a charge monitoring task for monitoring the charging state of a rechargeable battery precedes a roaming task for searching for a base station through a wireless LAN mounted on the portable printer. In this case, there may be a problem in that the roaming (i.e., searching for a base station) is delayed for a long period, consequently interrupting wireless communication halfway.

In other words, the charge monitoring task for monitoring the charging state of a rechargeable battery in the portable printer is of paramount importance when the battery is charging, but is not so important during the printer driving period. Nevertheless, the charge monitoring task has higher priority during the print driving period, which is problematic.

### BRIEF DESCRIPTION OF THE DRAWINGS

FIG. 1 is a perspective view showing the outward appearance of a portable printer according to one embodiment.

FIG. 2 is a perspective view showing the outward appearance of the portable printer whose cover is opened.

FIG. 3 is a schematic diagram illustrating a paper path.

FIG. 4 is a block diagram showing a control system employed in the portable printer.

FIG. 5 is a block diagram showing the configuration of a print controller.

FIG. 6 is a function block diagram illustrating a function associated with task control processing.

FIG. 7 is a flowchart illustrating a flow of task control processing.

### DETAILED DESCRIPTION

According to one embodiment, there is provided a printer that includes: a direct current power input unit supplied with direct current power; a rechargeable battery capable of being charged with the direct current power inputted from the direct current power input unit; and a task priority changing unit for determining the operational priority of a charge monitoring task to be higher than the operational priorities of other tasks when the rechargeable battery is being charged with the direct current power inputted from the direct current power input unit, and for determining the operational priority of the charge monitoring task to be lower than the operational priority of at least one of the other tasks when the rechargeable battery is not being charged with the direct current power inputted from the direct current power input unit.

According to another embodiment, there is provided a program for causing a computer used in controlling a printer including a direct current power input unit supplied with direct current power and a rechargeable battery capable of being charged with the direct current power inputted from the direct current power input unit, to serve as a task priority changing unit that determines the operational priority of a charge monitoring task to be higher than the operational priorities of other tasks when the rechargeable battery is being charged with the direct current power inputted from the direct current power input unit, and that determines the operational priority of the charge monitoring task to be lower than the operational priority of at least one of the other tasks when the rechargeable battery is not being charged with the direct current power inputted from the direct current power input unit.

According to a further embodiment, there is provided a task control method performed by a printer including a direct current power input unit supplied with direct current power and a rechargeable battery capable of being charged with the direct current power inputted from the direct current power input unit, the printer further including a control unit and a storage unit, wherein a task priority changing unit includes instructions executed by the control unit such that the control unit determines the operational priority of a charge monitoring task to be higher than the operational priorities of other tasks when the rechargeable battery is being charged with the direct current power inputted from the direct current power input unit, and determines the operational priority of the charge monitoring task to be lower than the operational priority of at least one of the other tasks when the rechargeable battery is not being charged with the direct current power inputted from the direct current power input unit.

Certain embodiments of a portable printer, a program and a task control method will now be described with reference to the accompanying drawings. The printer of one embodiment is a thermal portable printer that stores therein a paper roll wound with a label paper having a plurality of labels adhesively bonded to a backing sheet and performs printing with a thermal head.

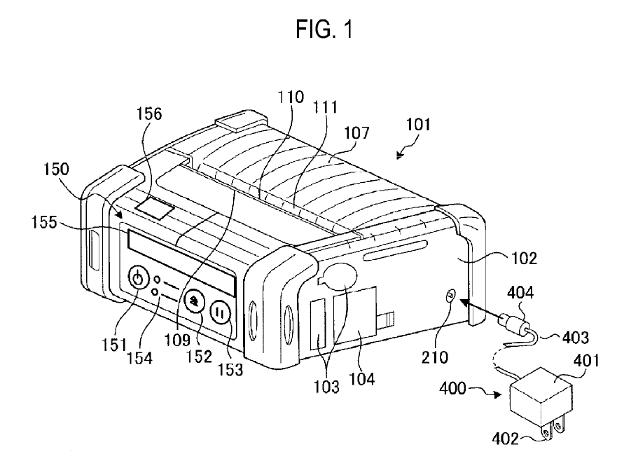

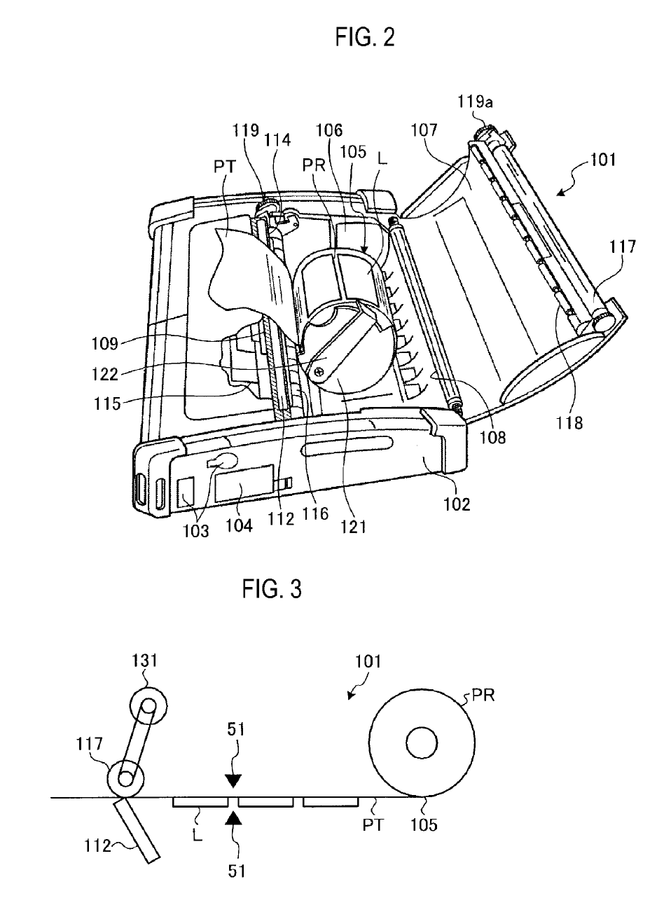

The general structure of a portable printer 101 is provided below. FIG. 1 is a perspective view showing the outward appearance of a portable printer according to one embodiment, and FIG. 2 is a perspective view showing the outward appearance of the portable printer whose cover is opened.

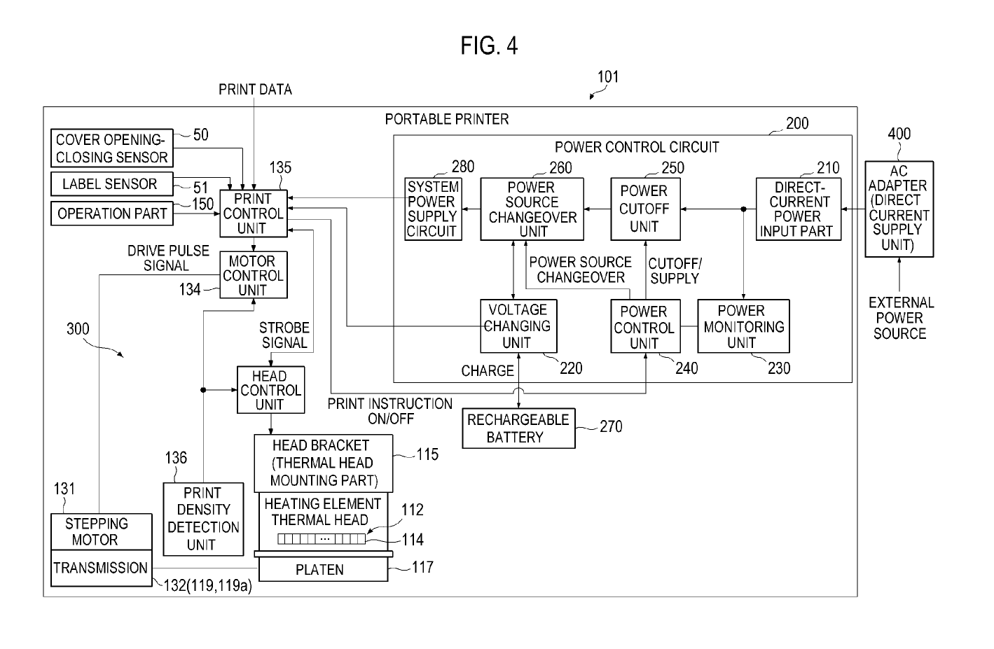

The outward appearance of the portable printer 101 is a rectangular parallelepiped shape. The housing 102 accommodates therein a print mechanism 300 (see FIG. 4) for carrying out a printing function and a paper feeding function, and a rechargeable battery 270 (see FIG. 4). In the present embodiment, a lithium-ion battery is used as the rechargeable battery 270. The housing 102 has an internal structure capable of storing a paper roll PR wound with a label paper PT having a plurality of labels L (see FIG. 2) bonded to a backing sheet. An opening 106 is located on the upper surface of the housing 102 so that the paper roll PR can be fed into the housing 102 through the opening 106. A cover 107 is located at the opening 106. The opening 106 is brought into an open state or a closed state by the opening or closing of the cover 107.

A cover opening-closing sensor 50 (see FIG. 4) for sensing the open state and the closed state of the cover 107 is provided in the housing 102. The cover opening-closing sensor 50 is in some embodiments a micro-switch, which is a mechanical sensor. When the cover 107 is released from the housing 102 to thereby open the opening 106, the cover opening-closing sensor 50 comes into an off-state in which no current flows. On the contrary, when the cover 107 covers the opening 106, the cover opening-closing sensor 50 comes into an on-state in which current flows. The cover opening-closing sensor 50 is not limited to the micro-switch. It is possible to use, a contactless switch provided with a photo sensor or other switches as the cover opening-closing sensor 50.

The cover 107 is attached to the inner side 108 of the housing 102 defining one side of the opening 106. A slot through which to take out the printed label paper PT in a widthwise direction of the portable printer 101 is formed, with the cover 107 being closed, between the outer side 111, which is the front end of the cover 107, and the front side 109, which is one side of the opening 106. This slot serves as a paper outlet 110.

A connector unit 103 having various connectors and a battery storage unit 104 for removably storing the rechargeable battery 270 are arranged on one side of the housing 102.

The front side 109 of the housing 102 or the outer side 111 of the cover 107, each defining the paper outlet 110, is formed in a knife-edge shape to cut the label paper PT discharged from the paper outlet 110.

A paper storage unit 105 capable of removably storing the paper roll PR is formed inside the housing 102. The paper roll PR is stored in the paper storage unit 105 with a roll shaft oriented in a widthwise direction of the portable printer 101. The paper roll PR is unwound by a platen 117 and conveyed toward the paper outlet 110 (see FIG. 1). A thermal head 112 is arranged to be opposed to the platen 117.

The thermal head 112 is removably mounted on a head bracket 115 arranged underneath the thermal head 112. The head bracket 115 is fixed to the housing 102 to bias the thermal head 112 in the inner upper direction of the portable printer 101. At the inner side of the portable printer 101, a head cover 116 is arranged near the thermal head 112. If necessary, the head cover 116 is mounted on the housing 102, thereby biasing the thermal head 112 to prevent vibration thereof.

The thermal head 112 is configured to have a plurality of heating element arrays 114 arranged in rows having a specified density. As the heating element arrays 114 generate heat under the control of a head control unit 133 (see FIG. 4), the thermal head 112 prints by heating the labels L of the label paper PT. Either, for example, a 203 dpi or 300 dpi thermal head may be selectively mounted on the head bracket 115.

A driving gear 119 is arranged within the housing 102. The driving gear 119 is turned by a drive power source, particularly a stepping motor 131 (see FIG. 4) operating under the control of a motor control unit 134 (see FIG. 4).

A paper pressing roller 118 is arranged near the platen 117 in the cover 107. The platen 117 and the paper pressing roller 118 are rotatable about their rotation shafts extending in a widthwise direction of the portable printer 101.

The platen 117 is arranged on the cover 107 in such a position that it can make contact with the heating element arrays 114 of the thermal head 112 when the cover 107 is closed. A driven gear 119a rotating together with the platen 117 is coupled to the left end of the platen 117 as seen from the front side of the portable printer 101.

If the cover 107 is closed, the driven gear 119a meshes with the driving gear 119 and is driven by the driving gear 119. The paper pressing roller 118 is coupled to the cover 107 in such a position that it can make contact with the head cover 116 when the cover 107 is closed. If the cover 107 is closed, the driven gear 119a attached to the cover 107 meshes with the driving gear 119, thus rotationally driving the platen 117 connected to the driven gear 119a. In the present embodiment, the driving gear 119 and the driven gear 119a make up a transmission 132 (see FIG. 4).

In the present embodiment, the paper roll PR is arranged within the paper storage unit 105 in such a fashion that it can be attached or removed by a lever 122. The paper roll PR is positioned between two guide fences 121, where the space between the two guide fences 121 can be adjusted in conformity with the width of the paper roll PR.

As shown in FIG. 3, a label sensor 51 for detecting the positions of the labels L adhesively bonded to the backing sheet of the label paper PT is provided on the paper path, which connects the paper storage unit 105 and the thermal head 112. More specifically, the label sensor 51 may be either a transmission-type sensor for detecting the gap between the labels L adhesively bonded to the backing sheet of the label paper PT or a reflection-type sensor for detecting the labels L adhesively bonded to the backing sheet of the label paper PT.

In the housing 102, there is also arranged a direct current power input unit 210 to which direct current power is supplied from an external power source. A plug 404 of an AC adapter 400 is inserted into the direct current power input unit 210, so as to supply direct current power to the portable printer 101.

The AC adapter 400 is formed independently of the portable printer 101 and is inserted into an external commercial power socket to output direct current power. The AC adapter 400 includes a main body 401 provided with a direct current conversion circuit therein, a socket plug 402 attached to the main body 401, a cable 403 through which direct current power is output and a cable plug 404. The 100V AC inputted from the socket plug 402 is converted to 20V DC and then output to the cable plug 404 provided at the end of the cable 403. In another embodiment, the portable printer may include an AC-DC converter within the housing 102.

In addition to the general-purpose AC adapter, it is possible to use a car adapter (with input and output power of 12V), a DC-DC converter (with input power of 10 to 60V and output power of 20V) or the like as the device for supplying direct current power to the direct current power input unit 210.

If the cable plug 404 is connected to the direct current power input unit 210, direct current power is supplied to the portable printer 101. Thus, the rechargeable battery 270 is brought into a rechargeable state.

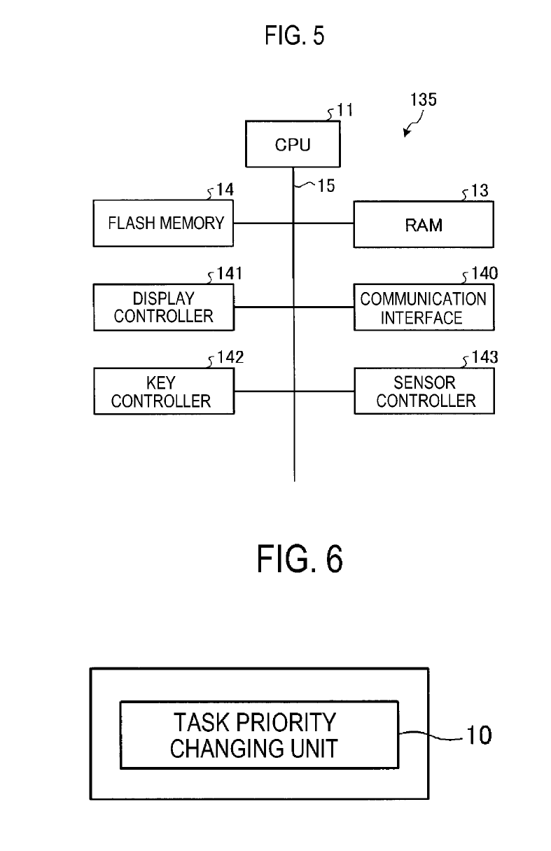

In the housing 102, there is also provided an operation part 150. The operation part 150 includes a power switch 151, a paper feeding button 152 provided for the user to instruct paper feeding, a pause button 153 provided for the user to pause paper feeding, an indicator 154 for notifying the user of the charging state of the rechargeable battery 270, a liquid crystal display (LCD) 155 and a communication window 156. In a nutshell, the portable printer 101 can perform data transmission and reception by infrared communication or other communication through the communication window 156 and a communication interface 140 (see FIG. 5). Thus, the portable printer 101 is capable of receiving, e.g., print data, and storing them in a random access memory (RAM) 13 or a flash memory 14 (see FIG. 5).

Next, the control system of the portable printer 101 is described. FIG. 4 is a block diagram showing the control system of the portable printer.

As shown in FIG. 4, the print mechanism 300 of the portable printer 101 includes a head control unit 133 for outputting print control signals inclusive of a strobe signal and a print signal to the thermal head 112 and a motor control unit 134 for outputting a drive pulse signal to the stepping motor 131. Further, a print control unit 135 controls all the printer parts, including the cover opening-closing sensor 50, the label sensor 51, the operation part 150 and the print mechanism 300.

The print mechanism 300 of the portable printer 101 includes a print density detection unit 136 for detecting whether the thermal head 112 mounted on the head bracket 115 has a print density of 300 dpi or a print density of 203 dpi.

FIG. 5 is a block diagram showing the configuration of the print control unit 135. As shown in FIG. 5, the print control unit 135 includes a CPU (central processing unit) 11 for performing various calculating processes to intensively control the respective parts. A RAM (random access memory) 13 and a non-volatile flash memory 14 are connected to the CPU 11 through a system bus 15.

The flash memory 14 stores the operation program of the portable printer 101 and various kinds of setting information. The setting information stored in the flash memory 14 includes the priority of the processing operations of various tasks. The CPU 11 controls the respective parts by copying, into the random access memory 13, the operation program stored in the flash memory 14 and executing the copied operation program. The operation program includes, e.g., the program for performing the task control processing which will be described below.

The RAM 13 temporarily stores various kinds of variable information. A partial area of the RAM 13 is used as a print buffer for extracting the print data (image data) to be printed on the labels L of the label paper PT. The print data refers to the data relating to the print object which is received from a host computer (not shown). The print data may be stored in the flash memory 14. The host computer includes, e.g., a personal computer, a cellular phone and a handy terminal, and performs various calculating processes in response to the operation input made by the user.

A communication interface 140, a display controller 141, a key controller 142 and a sensor controller 143 are connected to the CPU 11 through a system bus 15. Under the control of the CPU 11, the display controller 141 controls the display (of, e.g., the remaining battery level, the radio wave receiving condition or the error message) displayed on the LCD 155 of the operation part 150. Under the control of the CPU 11, the key controller 142 controls the key input received from the power switch 151, the paper feeding button 152 and the pause button 153 of the operation part 150. Under the control of the CPU 11, the sensor controller 143 controls the input from the sensors such as the cover opening-closing sensor 50 and the label sensor 51.

The communication interface 140 is an interface for communicating with external devices such as the host computer. The communication interface 140 is formed of, e.g., an infrared communication tool such as IrDA or the like, a USB (Universal Serial Bus), a wireless LAN (Local Area Network), RESISTOR-232C and Bluetooth® and thus, it is capable of communicating with the communication interface provided in the host computer.

The portable printer 101 further includes a power control circuit 200 within the housing 102. Responsive to the on/off operation of the power switch 151 of the operation part 150, the power control circuit 200 software-controls the supply and cutoff of the power supplied from the external commercial power socket through the AC adapter 400 or the power supplied from the rechargeable battery 270. As to the term “software-control,” it means that the supply and cutoff of the power is controlled by the control signal of the portable printer 101.

The power control circuit 200 includes a direct current power input unit 210, a voltage changing unit 220, a power monitoring unit 230, a power control unit 240, a power cutoff unit 250, a power source changeover unit 260 and a system power supply circuit 280 as a power supply unit.

The voltage changing unit 220 changes the voltage of the direct current power of a predetermined voltage range (e.g., 10V to 25V) inputted from the direct current power input unit 210 to a voltage suitable for use in the rechargeable battery 270 e.g., a voltage of 8.4V or 16.8V, which varies with the specification of the rechargeable battery 270. Since a lithium-ion battery is used as the rechargeable battery 270 in the present embodiment, the rechargeable battery 270 performs its charging operation in a CC/CV charging method, namely by dropping the external DC voltage and charging in a constant current/constant voltage.

When performing the charging operation, the voltage changing unit 220 can set a long-lifespan mode for prolonging the battery lifespan, by varying the charging voltage and current or by adjusting the recharge threshold value. The power monitoring unit 230 monitors the voltage of the direct current power supplied from the direct current power input unit 210. The power cutoff unit 250 serves to cut off the direct current power supplied from the direct current power input unit 210, if the voltage of the direct current power detected by the power monitoring unit 230 falls outside a predetermined range (e.g., a range of 10V to 25V). The power source changeover unit 260 serves to change over the drive power fed to the print mechanism 300, to power supplied from either the direct current power input unit 210 or the power supplied from the rechargeable battery 270.

The power control unit 240 performs the following control with respect to the power cutoff unit 250 and the power source changeover unit 260.

If the detection results of the power monitoring unit 230 show that the direct current power supplied from the direct current power input unit 210 falls within a predetermined range (10V to 25V), the power source changeover unit 260 is operated so that the direct current power supplied from the direct current power input unit 210 can flow to the voltage changing unit 220. This allows the direct current power (8.4V) for recharging to be fed from the voltage changing unit 220 to the rechargeable battery 270. In this state, the power supplied from the direct current power input unit 210 is also fed to the system power supply circuit 280.

Upon receiving a print signal from the print control unit 135 in a state that the direct current power is supplied externally to the direct current power input unit 210, the power control unit 240 operates the power source changeover unit 260 so that the drive power for the print mechanism 300 can be used as the power for the rechargeable battery 270. According to the above description, if there is a print instruction, the power supplied from the direct current power input unit 210 to the print mechanism 300 is cut off. However, if the voltage supplied from the direct current power input unit 210 falls within the predetermined range, the power to the print control unit 135 is fed from the direct current power input unit 210.

Even when there is no print instruction, the power control unit 240 operates the power source changeover unit 260 to feed the power from the rechargeable battery 270 to the system power supply circuit 280 if the voltage of the direct current power detected by the power monitoring unit 230 is lower than the voltage of the rechargeable battery 270.

The system power supply circuit 280 feeds the power to each part of the print mechanism 300 through the print control unit 135. The power within the range of allowable voltage is applied to the thermal head 112 of the print mechanism 300. In other words, when the portable printer 101 performs printing, the power supplied from the direct current power input unit 210 is cut off by the power cutoff unit 250 but the power from the rechargeable battery 270 is fed to the thermal head 112. This means that a voltage greater than the allowable voltage of the thermal head 112 is not fed to the thermal head 112.

The system power supply circuit 280 feeds the power (of, e.g., 5V, 3.3V or 1.5V in voltage) needed to drive the print control unit 135. Thus, in the system power supply circuit 280, the operation input voltages to be fed to each part are set to ensure that the respective parts can properly operate within the range of the voltage of the external direct current power and the rechargeable battery 270.

The system power supply circuit 280 performs the on/off control of each power supply system that is driven by the direct current power supplied from the rechargeable battery 270 and the direct current power input unit 210. In other words, the system power supply circuit 280 allows the direct current power to be fed from the direct current power input unit 210 to the print control unit 135 if the direct current power input unit 210 is supplied with the direct current power. In contrast, the system power supply circuit 280 allows the direct current power to be fed from the rechargeable battery 270 to the print control unit 135 if the direct current power input unit 210 is not supplied with the direct current power.

When the power control unit 240 allows the direct current power to be fed from the rechargeable battery 270 to the print control unit 135, the system power supply circuit 280 feeds the direct current power to the print mechanism 300 via the print control unit 135.

In addition to controlling the print mechanism 300, the print control unit 135 acquires information delivered from the voltage changing unit 220 and the system power supply circuit 280 during the power supplying period and if the voltage changing unit 220 and the system power supply circuit 280 are in a condition where they can be charged, transmits charge startup instructions to the power control unit 240.

The print control unit 135 sets the portable printer 101 in different status modes depending on the circumstances. The status modes include, for example, a standby mode in which the thermal head 112 can perform printing at once, a sleep mode in which the system stays in an energy-saving state to reduce power consumption, a print mode in which printing is performed by the thermal head 112, a charge mode in which the rechargeable battery 270 is charged and a long-lifespan charge mode in which charging is performed at a low voltage without shortening the lifespan of the rechargeable battery 270.

Transition to the respective modes is controlled in the following manner.

When the portable printer 101 is driven by the rechargeable battery 270, it goes into sleep mode if it remains in standby mode for a predetermined amount of time. In the sleep mode, the power supply to unnecessary functional parts is cut off, but the communication interface 140 stays in a standby state. The sleep mode comes back to the standby mode if there is a need to operate the print mechanism 300 or if signal transmission or reception occurs in the communication interface 140 during the sleep mode.

When the portable printer 101 is supplied with external direct current power, it goes into standby mode without going into sleep mode. This makes it possible to rapidly start up the print mode. In the standby mode, the communication interface 140 is kept in a standby state and the voltage changing unit 220 controls the charging operation of the rechargeable battery 270.

In the portable printer 101 described above, if the paper roll PR is put into the paper storage unit 105 and the label paper PT is pulled out and then the cover 107 is closed, the pulled-out label paper PT is placed between the thermal head 112 and the platen 117 and between the head cover 116 and the paper pressing roller 118. In case it goes into the print mode under the control of the print control unit 135 with the above state, the label paper PT is conveyed from the paper roll PR toward the paper outlet 110 through the thermal head 112 if the stepping motor 131 is driven by the control of the motor control unit 134. The thermal head 112 causes the heating element arrays 114 to generate heat under the control of the head control unit 133, thereby printing specific content on the labels L of the conveying label paper PT.

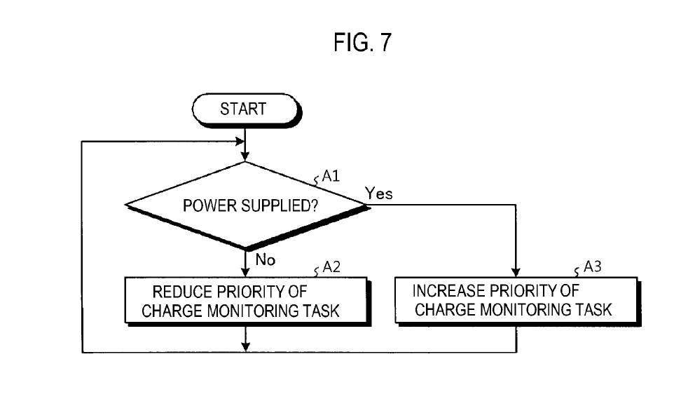

Next, the task control processing performed by the CPU 11 according to the program stored in the flash memory 14 will be described with reference to the function block diagram shown in FIG. 6 and the flowchart illustrated in FIG. 7.

The program executed in the portable printer 101 of the present embodiment has a module configuration including a task priority changing unit 10 shown in FIG. 6. In the actual hardware, as the CPU 11 reads the program from the flash memory 14 and executes the same, the individual parts mentioned above are loaded onto the RAM 13 and thus, the task priority changing unit 10 is generated on the RAM 13.

As illustrated in FIG. 7, when the portable printer 101 goes into the sleep mode to keep the system in an energy-saving state for reducing the power consumption, the task priority changing unit 10 determines whether direct current power is supplied from outside the portable printer 101 to the direct current power input unit 210 (act A1).

If it is determined that the direct current power is not supplied from outside the portable printer 101 to the direct current power input unit 210 (if “No” in act A1), the rechargeable battery 270 is not charging. Therefore, the task priority changing unit 10 reduces the priority of the charge monitoring task for monitoring the charging state of the rechargeable battery 270, (act A2). Therefore, when the operational priority of the charge monitoring task is lower than the operational priority of, e.g., a roaming task for searching a base station through the communication interface 140, i.e., a wireless LAN, mounted on the portable printer 101, the roaming task may be performed preferentially. Since the processing speed of the CPU 11 is slowed in sleep mode, it takes more time in sleep mode to perform the roaming task than in a normal operation period. However, it is sufficient for the CPU 11 to perform the roaming task in sleep mode. In some embodiments, when operating the portable printer 101 with the rechargeable battery 270, no overcharging occurs even if the charge monitoring is delayed.

On the other hand, even though the operational priority of the charge monitoring task has been reduced, the task priority changing unit 10 increases the operational priority of the charge monitoring task on the rechargeable battery 270 (act A3) if the socket plug 404 of the AC adapter 400 inserted into a commercial power socket is connected to the direct current power input unit 210 so that the direct current power can be supplied to the portable printer 101 (if “Yes” in act A1). Inasmuch as the portable printer 101 is kept immovable while the rechargeable battery 270 is charged, the possibility of performing the roaming task at that time remains low. This means that no problem arises even if the roaming task is not performed preferentially.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a Solid-state computer storage media. The functions obtained by installation or download in advance in this way can be realized in cooperation with an OS(Operating System) or the like in the apparatus.

According to the present embodiment described above, the operational priority of the charge monitoring task for monitoring the charging state of the rechargeable battery 270 is kept higher than the operational priorities of other tasks when the rechargeable battery 270 is charged with the direct current power inputted from the direct current power input unit 210. In contrast, the operational priority of the charge monitoring task is kept lower than the operational priority of at least one of other tasks when the rechargeable battery 270 is not charging. In some embodiments it is possible to preferentially perform other tasks than the charge monitoring task when the rechargeable battery 270 is not charging (e.g., when the printer is in operation). More specifically, the charge monitoring task in some embodiments is of paramount importance when the rechargeable battery 270 is charging, but is not so important when the rechargeable battery 270 is not charging (e.g., when the printer operates). By keeping the priorities of other tasks (e.g., a roaming task for searching a base station through a wireless LAN) higher than the priority of the charge monitoring task, it is possible in some embodiments to preferentially perform other tasks than the charge monitoring task (e.g., a roaming task for searching a base station through a wireless LAN), which have an importance when the rechargeable battery 270 is not charging (e.g., during the printer driving period).

In particular, if the priority of the roaming task is lower than that of the charge monitoring task in the sleep mode in which the system is kept in an energy-saving state to reduce power consumption, where the rechargeable battery 270 is not charging, the roaming (i.e., searching the base station) becomes delayed due to the reduced processing speed of a CPU and, consequently, the wireless communication may be interrupted halfway. This problem can be solved by preferentially performing the roaming task.

Although the program executed in the portable printer 101 of the present embodiment is preliminarily incorporated in the flash memory 14 according to the description made above, the present embodiment is not limited thereto. Alternatively, the program executed in the portable printer 101 of the present embodiment may be provided by recording the same in a computer-readable recording medium such as a CD-ROM, a flexible disk (FD), a CD-R or a DVD (Digital Versatile Disk) as an installable or executable file.

In addition, the program executed in the portable printer 101 of the present embodiment may be stored in a computer connected to a network such as the Internet or the like so that the program can be down-loaded from the computer via the network. Moreover, the program executed in the portable printer 101 of the present embodiment may be provided or disseminated via a network such as the Internet or the like.

While certain embodiments have been described above, these embodiments have been presented by way of example only, and are not intended to limit the scope of the inventions. Indeed, the novel printer, the novel program and the novel task control method described herein may be embodied in a variety of other forms; furthermore, various omissions, substitutions and changes in the form of the printer, the program and the task control method described herein may be made without departing from the spirit of the inventions. The accompanying claims and their equivalents are intended to cover such forms or modifications as would fall within the scope and spirit of the inventions.

What is claimed is:

1. A printer comprising:
an electric power input unit supplied with electric power;
a battery charger to charge a rechargeable battery being charged with the electric power inputted from the electric power input unit; and
a task priority changing unit capable of determining operational priority of a charge monitoring task to be higher than operational priorities of other tasks when the rechargeable battery is being charged with the electric power inputted from the electric power input unit, and that is capable of determining the operational priority of the charge monitoring task to be lower than the operational priority of at least one of the other tasks when the rechargeable battery is not being charged with the electric power inputted from the electric power input unit.

2. The printer of claim 1, wherein when the task priority changing unit determines the electric power is not being supplied from outside the printer to the electric power input unit, the printer goes into a sleep mode which is an energy-saving state to reduce power consumption.

3. The printer of claim 1, wherein when the task priority changing unit determines the electric power is being supplied from outside the printer to the electric power input unit, the printer goes into standby mode.

4. The printer of claim 2, wherein the printer goes into sleep mode after a predetermined amount of time.

5. The printer of claim 1, wherein the task priority changing unit determines the operational priority of the charge monitoring task to be higher than the operational priority of a roaming task that searches a base station through wireless communication when the rechargeable battery is being charged with the electric power inputted from the electric power input unit, and determines the operational priority of the charge monitoring task to be lower than the operational priority of the roaming task when the rechargeable battery is not being charged with the electric power inputted from the electric power input unit.

6. The printer of claim 1, wherein the electric power is a direct current and is supplied from outside the printer.

7. The printer of claim 1, wherein the charge monitoring task monitors the charging state of the rechargeable battery.

8. A computer readable storage medium storing instructions for controlling a printer, the instructions stored on the computer readable storage medium comprising:
supplying electric power to a electric power input unit connected to a rechargeable battery;
maintaining, through a task priority changing unit, operational priority of a charge monitoring task of the rechargeable battery higher than the operational priorities of other tasks when the rechargeable battery is being charged with the electric power inputted from the electric power input unit; and
maintaining, through the task priority changing unit, operational priority of the charge monitoring task lower than the operational priority of at least one of the other tasks when the rechargeable battery is not being charged with the electric power inputted from the electric power input unit.

9. The computer readable storage medium of claim 8, further comprising placing the printer in sleep mode, which is an energy-saving state to reduce power consumption, when the task priority changing unit determines the electric power is not being supplied from outside the printer to the electric power input unit.

10. The computer readable storage medium of claim 8, further comprising placing the printer in standby mode when the task priority changing unit determines the electric power is being supplied from outside the printer to the electric power input unit.

11. The computer readable storage medium of claim 10, further comprising placing the printer into sleep mode after a predetermined amount of time.

12. The computer readable storage medium of claim 8, further comprising determining the operational priority of the charge monitoring task to be higher than the operational priority of a roaming task that searches a base station through wireless communication when the rechargeable battery is being charged with the electric power inputted from the electric power input unit, and determining the operational priority of the charge monitoring task to be lower than the operational priority of the roaming task when the rechargeable battery is not being charged with the electric power inputted from the electric power input unit.

13. The computer readable storage medium of claim 8, further comprising receiving direct current power from outside the printer.

14. A task control method comprising:
supplying electric power to an electric power input unit connected to a rechargeable battery;
maintaining, through a task priority changing unit, operational priority of a charge monitoring task of the rechargeable battery higher than the operational priorities of other tasks when the rechargeable battery is being charged with the electric power inputted from the electric power input unit; and
maintaining, through the task priority changing unit, operational priority of the charge monitoring task lower than the operational priority of at least one of the other tasks when the rechargeable battery is not being charged with the electric power inputted from the electric power input unit.

15. The task control method of claim 14, further comprising placing the printer in sleep mode, which is an energy-saving state to reduce power consumption, when the task priority changing unit determines the electric power is not being supplied from outside the printer to the electric power input unit.

16. The task control method of claim 14, further comprising placing the printer in standby mode when the task priority changing unit determines the electric power is being supplied from outside the printer to the electric power input unit.

17. The task control method of claim 16, further comprising placing the printer into sleep mode after a predetermined amount of time.

18. The task control method of claim 14, further comprising determining the operational priority of the charge monitoring task to be higher than the operational priority of a roaming task that searches a base station through wireless communication when the rechargeable battery is being charged with the electric power inputted from the electric power input unit, and determining the operational priority of the charge monitoring task to be lower than the operational priority of the roaming task when the rechargeable battery is not being charged with the electric power inputted from the electric power input unit.

19. The task control method of claim 14, further comprising receiving direct current power from outside the printer.

20. The task control method of claim 14, wherein the charge monitoring task monitors the charging state of the rechargeable battery.
